(19) United States
(12) Patent Application Publication
(10) Pub. No.: US 2026/0152652 A1
(43) Pub. Date: Jun. 4, 2026

(54) COATING WITH ENHANCED ACOUSTICAL PERFORMANCE AND THE METHOD THEREOF

(71) Applicant: USG Interiors, LLC, Chicago, IL (US)

(72) Inventors: DONG GUO, Buffalo Grove, IL (US); ADAM WARREN KELLER, Grayslake, IL (US); TIMOTHY JOE MILLER, Mundelein, IL (US); RAFAEL BURY, Wheeling, IL (US)

(21) Appl. No.: 18/964,888

(22) Filed: Dec. 2, 2024

(51) Int. Cl. C09D 7/65; E04B 9/00; E04F 13/08

(52) U.S. Cl. CPC C09D 7/65; E04F 13/0867; E04B 9/001

(57) ABSTRACT

A coating primarily including water, pigment and binder typically used for ceiling tile including a percentage of wetting agent effective when coated and dried on fleece or soft polymer substrate to increase the sound absorption coefficient of the fleece or soft polymer cloth substrate on top of a base board or ceiling tile.

### BACKGROUND OF THE INVENTION

Acoustical tiles for indoor use such as a room, hallway, conference hall, or the like are designed to be able to absorb sound and/or reduce sound transmission in addition to isolation and aesthetic effect. Acoustical ceiling tile usually consists of a panel and top and bottom coatings. A common type of acoustical panel is generally composed of mineral wool fibers, fillers, colorants, and a binder. To prepare acoustical panels, fibers, fillers, bulking agents, binders, water, surfactants, and other additives are typically combined to form a slurry and processed. Cellulosic fibers are typically in the form of recycled newsprint. The bulking agent is typically expanded perlite. Fillers may include clay, calcium carbonate or calcium sulfate. Binders may include starch and latex. The coatings usually comprise organic or inorganic binders and fillers like clay, calcium carbonate, surfactants, and other additives. The coatings impart mechanical strength and aesthetic effects to the ceiling tile.

A modified ceiling tile system is tile with removable fleece or veils plus coatings instead of only coatings. Normal coatings on ceiling tiles are not removable and therefore the color, appearance and patterns cannot be changed unless to change the tiles. The removable system with thin, porous fleece or veils achieved by mini hooks and loop layers has the advantages when a new appearance is needed. Coatings that can impart different color, pattern or textures can be applied on the fleece.

Usually, coatings or any additional surface layers on the tile can cause deteriorated acoustical performance because the coatings will cause lower porosities and affect the sound absorption. Therefore, coatings that with minimal influence in affecting the acoustical performance are desirable.

It will be appreciated that this background description has been created by the inventors to aid the reader, and is neither a reference to prior art nor an indication that any of the indicated problems were themselves appreciated in the art. While the described principles can, in some regards and embodiments, alleviate the problems inherent in other systems, it will be appreciated that the scope of the protected innovation is defined by the attached claims, and not by the ability of the claimed invention to solve any specific problem noted herein.

### PRIOR ART

It is known to provide a removable fleece top layer made of polyester, nylon, or other polymer to improve the flexibility, or to change the texture, color or appearance without the need to change the entire ceiling tile. This removable fleece top layer may also improve a sound absorption coefficient (or noise reduction coefficient). A higher sound absorption coefficient value indicates better sound absorption performance. It is also known that fleece may be coated with a coating of a desired color for aesthetics.

Acoustical ceiling tiles consisting of a gypsum or mineral wool board panels are systems designed to improve the acoustics by absorbing sound and/or reducing sound transmission in an indoor space, such as an office room, conference hall, or the like. The ceiling tiles may also provide an aesthetic effect for an indoor space. Although there are numerous types of acoustical panels, a common variety of acoustical panel is generally composed of mineral wool fibers, fillers, colorants, and a binder. These materials, in addition to a variety of others, can be employed to provide acoustical panels with desirable acoustical properties and other properties, such as color and appearance.

One method used to improve the acoustic performance and aesthetic effect of the ceiling tile is to provide coatings on both backing side and an opposing facing side of the tile. A special type of ceiling tile is thus designed, which has a removable facing porous textile or fabric layer. Different from conventional ceiling tiles, the coating in this system is a layer of coated porous fabric with different color or patterns. Its porosity is designed to absorb sound and to improve the sound absorption ratio of the ceiling tile. A coating is still needed to apply on top of the fabric. The coating usually comprises inorganic fillers, such as clay and calcium carbonate, and binding materials like emulsion binders to adjust the physical properties of the fabric and facilitate the coating process. More specifically, the coating includes large particles which pack together on the surface of the fabric to form a rough surface intended to improve sound absorption. However, these coating layers can have the opposite effect and may reduce the sound absorption performance of the tiles. For example, in the case of the fabric covered tiles, the coatings applied on the fabric may fill in the pores and affect its sound absorption effect. Such coatings may also have a high viscosity and must be applied by spraying. Therefore, there is a need to make modified coating that can be more easily applied and will not cause deteriorated acoustical performance.

### SUMMARY OF THE INVENTION

The invention involves the use of a special wetting agent in aqueous coatings for fleece or polymer cloth covered special ceiling tiles. Compared to conventional coatings, the coating with the wetting agent can provide a higher sound absorption coefficient due to the formation of a special microstructure of the coatings, which gives rise to a special acoustic effect, namely improved sound absorption. Furthermore, the wetting agent modified coating can provide the fleece or cloth covered ceiling tile with a sound absorption coefficient even higher than the fleece or polymer cloth covered tile without any coatings. The wetting agent modifies the surface tension of the coating on the fleece or soft polymer type fabric substrates and results in a porous or rough structure that can absorb sound.

### DESCRIPTION OF THE PREFERRED EMBODIMENT

The terminology as set forth herein is for description of the embodiments only and should not be construed as limiting the invention as a whole. Herein, when a range such as 5-25 (or 5 to 25) is given, this means preferably at least or more than 5 and, separately and independently, preferably not more than or less than 25. In an example, such a range defines independently 5 or more, and separately and independently, 25 or less. Moreover, all ranges disclosed herein are to be understood to encompass any and all values and sub-ranges between the stated values.

As used herein, the term “about” means that amounts, sizes, formulations, parameters, and other quantities and characteristics are not and need not be exact but may be approximate and/or larger or smaller, as desired, reflecting tolerances, conversion factors, rounding off, measurement error and the like, and other factors. When the term “about” is used in describing a value or an endpoint of a range, the disclosure should be understood to include the specific value or endpoint referred to. Whether or not a numerical value or endpoint of a range in the specification recites “about,” the numerical value or endpoint of a range is intended to include two embodiments: one modified by “about,” and one not modified by “about.” It will be further understood that the endpoints of each of the ranges are significant both in relation to the other endpoint, and independently of the other endpoint.

Provided herein are ceiling tiles including top covers and coatings applied to the top covers. For certain types of ceiling tiles, fleece or fabric with polyester, nylon or other polymer as the main compositions are used as top covers. The fleece or fabric top covers impart a distinct aesthetic effect and are removable so that the top covers can be changed to provide the tile with a new appearance without the need to remove and replace the whole tile. Fleece, being made of polyester fiber, can also be used for acoustic absorption, and is used in practicing the present invention.

In this type of fleece or fabric covered ceiling tile, a coating is also applied on top of the fleece to provide the whole tile system with desired patterns or appearance and improved mechanical strength. Typically, however, such coatings will usually reduce the sound absorption coefficient of the tile system. However, the coatings provided herein provide for improved sound absorption of the tile system.

Coatings for use on the top covers of the present disclosure include water, one or more surfactants, one or more fillers, one or more pigments, and a wetting agent.

Water is included in an amount of about 20% to about 90%, about 30% to about 80%, or about 40% to about 70% by weight based on the total weight of the coating.

The one or more fillers are included in the coating for improving the vibration and sound dampening capabilities of the coating. Useful fillers include clays, mica, talc, calcium carbonate, calcium magnesium carbonate, calcium silicate, aluminum hydroxide, aluminum, montmorillonite flakes, glass flakes, metal flakes, graphene, graphite, iron oxide, cellulose fibers, mineral fibers, carbon fibers, silica, and mixtures thereof.

The filler(s) can comprise about 20% to about 90%, about 25% to about 75%, about 30% to about 60%, or about 35% to about 55% by weight based on the total weight of the coating.

The coating also includes one or more surfactants. Suitable surfactants include defoamers, dispersants, and emulsifiers.

One or more dispersants may be included in the coating to facilitate the dispersion of the filler(s) and other solid components in the coating, and may improve the color strength, opacity, and gloss of the coating. Exemplary dispersants include inorganic dispersants, such as metal-containing compounds or salts, such as sodium, potassium or ammonium compounds, or polymeric compounds, such as polyacrylates, polyester, polyether, or polyurethane-based systems.

The dispersant(s) can be included in an amount of about 0.1% to about 1%, about 0.2% to about 0.8%, or about 0.3% to about 0.5% by weight based on the total weight of the coating.

One or more emulsion binders may be included in the coating to reduce the coating's drying time and improve its ability to adhere to a variety of surfaces. Emulsion binders may include, for example, acrylic polymers derived from acrylic acid or methacrylic acid.

The emulsion binder(s) can be included in an amount of about 1% to about 20%, about 3% to about 15%, or about 5% to about 10% by weight based on the total weight of the coating.

One or more defoamers may be included to control the formation of foam in production or application of the coating and reduce foam-related defects. Exemplary defoamers may include mineral oil, silicone-based defoamers (i.e., PDMS), tri-n-butyl phosphate systems, or alkoxane polymer-based systems.

The defoamer(s) can be included in an amount of about 0.1% to about 1%, about 0.2% to about 0.8%, or about 0.3% to about 0.5% by weight based on the total weight of the coating.

One or more thickeners may be included to enhance the viscosity of the paint. Exemplary thickeners may include known cellulosic, synthetic, or natural thickeners.

The thickener(s) can be included in an amount of about 0.1% to about 1%, about 0.2% to about 0.8%, or about 0.3% to about 0.5% by weight based on the total weight of the coating.

The coating also contains a pigment to provide a desired color to the coating. Exemplary pigments may include titanium dioxide and others known to the art.

The pigment may be included in an amount of about 0.5% to about 10%, about 1% to about 5%, or about 1.5% to about 2.5% by weight based on the total weight of the coating.

The coating has a total solids content of about 30% to about 70%, about 35% to about 65%, or about 40% to about 60 wt. %, based on the total coating composition prior to any drying and/or curing of the coating.

In one example, a typical coating composition may include 12 wt. % of binder, 20 wt. % clay, 15 wt. % calcium carbonate (as an inorganic filler), titanium dioxide, and 0.2-1 wt. % each of dispersant(s), thickener(s), defoamer(s), in addition to water, by weight of the total coating. In another example, the coating composition may include 45.5 wt. % water, 0.1 wt. % dispersant, 25 wt. % carbonate, 7 wt. % titanium dioxide, 10 wt. % clay, 0.1 wt. % defoamer, 12 wt. % binder, and 0.3 wt. % thickener by weight of the total coating.

It has been discovered that the sound absorption coefficient of fleece and polymer cloth top covers can be improved by including a wetting agent in the coating. A wetting agent possesses a hydrophilic and a hydrophobic part that self-orientates at a surface to reduce the surface tension of the coating. Suitable wetting agents for use in the coating include silicone-based agents, such as BYK-349 and BYK-3480 Marketed by BYK-USA Inc. For purposes of this disclosure, the wetting agent is not to be considered a surfactant in the ‘at least one or more surfactants’ detailed above.

The wetting agent is provided in an amount of about 1% to about 2%, by weight, relative to the weight of the total weight of solids in the coating. The wetting agent-containing coatings can provide a sound absorption coefficient to the whole tile system even higher than that of the tile with fleece or polymer cloth top covers without any coating. It is believed that this results from modification of the surface tension of coating on the fleece or soft-polymer substrates so that the dried coating particles form a special porous/rough structure on the fleece that is more capable of absorbing sound.

The wetting-agent enhanced paint or coating is applied to the fleece with a sprayer or hand roller and allowed to dry.

The wetting agent-enhanced paint or coating can increase the sound absorption values of the tiles covered with fleece or similar substrate consisting of polymer cloth. The paint or coating can provide a sound absorption value even higher than that of the tile with pure fleece cover but without any coatings.

The following examples demonstrate the efficacy of the invention.

In a first example, a first batch of coating containing water, clay, calcium carbonate, surfactant, an emulsion binder, and a biocide was prepared and coated onto a swatch of fleece (3039-1-1). A second batch of coating containing the same components of the first batch in same amounts was prepared later and coated on a separate swatch of fleece (3039-1-2).

A third batch of coating were prepared containing the same components of the first batch in the same amount and additionally containing 1.5 wt. % of BYK-349 as a wetting agent, and then coated onto a swatch of fleece (3039-B1).

The coated fleece samples 3039-B1 and 3039-1-1 were then applied to samples of basemat (i.e., baseboard) component of a ceiling tile. For reference, Basemat 1 and Basemat 2 noted in Example 1 below are different samples taken from the same type of basemat. The difference in average sound absorption values were believed to be due to differences in sample variation, which is common for many acoustic tests based on the sound absorption at multiple different frequencies.

The uncoated fleece (Ref-fleece), the basemat alone (Basemat 1, Basemat 2), the uncoated fleece on basemat (Ref-Fleece on basemat), the first and second coatings on fleece (3039-1-1, 3039-1-2), and the third and fourth coatings on fleece applied to basemat (3039-B1 on basemat, 3039-B2 on basemat) were separately placed in a sound tube and exposed to white noise sound as per ASTM E-1050 and frequency dependent sound absorption was recorded. Observed sound absorption coefficient values were recorded. Estimated sound absorption coefficient values for each sample were obtained by averaging the sound absorption coefficients observed at multiple frequencies. The estimated sound absorption coefficient values obtained are detailed in Example 1 below.

### Example 1

| | Estimated Sound Absorption |
|---|---|
| Samples | Coefficient Values |
| 3039-1-1 | 0.374 |
| 3039-1-2 | 0.366 |
| 3039-B1 on basemat 1 | 0.982 |
| 3039-1-1 on basemat 1 | 0.746 |
| Basemat 1 | 0.552 |
| Basemat 2 | 0.375 |
| Ref-fleece | 0.148 |
| Ref-Fleece on basemat | 0.932 |

As is clear from Example 1, ‘3039-B1 on basemat’ has the highest estimated sound absorption coefficient value tested, higher even than ‘3039-1-1 on basemat’. This indicates that the wetting agent helped to improve the amount of sound absorbed.

### Example 2

| | Estimated Sound Absorption |
|---|---|
| Samples | Coefficient Values |
| 3039-2-1 | 0.360 |
| 3039-2-2 | 0.183 |
| 3039-B2 on basemat | 0.971 |
| 3039-B2 on basemat2 | 0.982 |
| 3039-2-1 on basemat | 0.709 |
| 3039-2-1 on basemat2 | 0.714 |
| Ref-Fleece on basemat | 0.935 |

In a second example, a first batch of coating containing water, clay, calcium carbonate, surfactant, an emulsion binder, and a biocide was prepared and coated onto a swatch of fleece (3039-2-1). A second batch of coating containing the same components of the first batch in same amounts was prepared later and coated on a separate swatch of fleece (3039-2-2).

A third batch of coating was prepared containing the same components of the first batch in the same amount and additionally containing 1.5 wt. % of BYK-3480 as a wetting agent, and then coated onto a swatch of fleece (3039-B2).

Samples of the coated fleece samples 3039-B2 and 3039-2-1 were then applied to samples of basemat 1 and basemat 2, respectively.

The sound absorption of the uncoated fleece (Ref-fleece), the uncoated fleece on basemat (Ref-Fleece on basemat), the first and second coatings on fleece (3039-2-1, 3039-2-2), and the first and third coatings on fleece applied to basemat1 and basemat 2 (3039-B2 on basemat1, 3039-B2 on basemat2, 3039-2-1 on basemat1, 3039-2-1 on basemat2) were measured in the manner detailed above for Example 1.

As the table above for Example 2 illustrates, the wetting agent-containing coating produced higher sound absorption values than the unmodified coatings when applied to basemats. This suggests that the wetting agent enhances the sound absorption value of the coating.

It should be evident that this disclosure is by way of example and that various changes may be made by adding, modifying, or eliminating details without departing from the fair scope of the teaching contained in this disclosure. The invention is therefore not limited to particular details of this disclosure except to the extent that the following claims are necessarily so limited.

What is claimed is:

1. A coating comprising water, one or more fillers, one or more surfactants, one or more pigments, and a wetting agent in an amount effective to increase a sound absorption coefficient of a fleece or soft polymer substrate applied to a basemat when coated thereon.

2. The coating of claim 1, wherein the amount of wetting agent is about 1% to about 2% by weight of a total weight of solids in the coating.

3. The coating of claim 1, wherein the wetting agent is silicone-based.

4. The coating of claim 1, wherein the at least one or more surfactants are selected from the group consisting of a defoamer, a dispersant, an emulsifier, and mixtures thereof.

5. The coating of claim 4, wherein the defoamer is present in an amount of about 0.1% wt. to about 1% wt. by weight of the coating.

6. The coating of claim 4, wherein the dispersant is present in an amount of about 0.1% wt. to about 1% wt. by weight of the coating.

7. The coating of claim 4, wherein the emulsifier is present in an amount of about 0.1% wt. to about 1% wt. by weight of the coating.

8. The coating of claim 1, wherein the wetting agent increases the sound absorption coefficient by at least about 0.15.

9. A tile system comprising:
a basemat;
a fleece or soft polymer substrate applied to a surface of the basemat; and
a coating comprising water, one or more fillers, one or more surfactants, one or more pigments, and a wetting agent in an amount effective to increase a sound absorption coefficient of the ceiling tile system; said coating applied to the fleece or soft polymer substrate.

10. The system of claim 9, wherein the fleece or soft polymer substrate is removable from the surface of the basemat.

11. The system of claim 8, wherein the wetting agent increases the sound absorption coefficient of the ceiling tile system by at least about 0.15.

12. The system of claim 9, wherein the amount of wetting agent is about 1% to about 2% by weight of a total weight of solids in the coating.

13. The system of claim 9, wherein the wetting agent is silicone-based.

14. The ceiling tile system of claim 9, wherein the basemat is a gypsum or mineral wool board panel.

15. A method of improving a sound absorption coefficient of a fleece or soft polymer cloth substrate applied to a basemat, the method comprising:
preparing a coating comprising water, one or more fillers, one or more surfactants, one or more pigments, and a wetting agent;
coating the fleece or soft polymer cloth substrate with the coating to form a coated fleece; and
applying the coated fleece or soft polymer cloth substrate to a surface of a basemat.

16. The method of claim 15, wherein the coating comprises the wetting agent in an amount of about 1% to about 2% by weight of a total weight of solids in the coating.

17. The method of claim 15, wherein the wetting agent increases the sound absorption coefficient of the fleece or soft polymer substrate applied to the basemat by at least about 0.15.

18. The method of claim 15, wherein the coating is coated on the fleece or soft polymer substrate with a sprayer or hand roller.

19. The method of claim 15, wherein the coating on the coated fleece or soft polymer substrate is dried before the coated fleece or soft polymer substrate is applied to the surface of the basemat.
